(19) United States
(12) Patent Application Publication
(10) Pub. No.: US 2009/0290730 A1
(43) Pub. Date: Nov. 26, 2009

(54) BONE CONDUCTION SPEAKER

(75) Inventors: Mikio Fukuda, Tokyo (JP); Takeshi Takeda, Tokyo (JP)

Correspondence Address: SCHMEISER, OLSEN & WATTS, 22 CENTURY HILL DRIVE, SUITE 302, LATHAM, NY, 12110, US

(73) Assignee: TEMCO JAPAN CO., LTD., SUGINAMI-KU, TOKYO (JP)

(21) Appl. No.: 12/439,563

(22) PCT Filed: Sep. 6, 2007
(86) PCT No.: PCT/JP07/00968

§ 371 Date: Mar. 2, 2009

(30) Foreign Application Priority Data
Sep. 7, 2006 (JP) 2006-242999

(51) Int. Cl. H04R 1/00

(52) U.S. Cl. 381/151

(57) ABSTRACT

A bone conductive speaker in which the hearing of external sounds is not inhibited because the earhole is not closed, the hearing efficiency is high and the sound leakage is small because the tragus portion is vibrated locally, and moreover the configuration is simple and the putting-on and taking-off operations are easy to perform. The bone conductive speaker comprises a bone conductive speaker body (1) and holding means (2) which is attached to the bone conductive speaker body (1) to hold the bone conductive speaker body (1) so that the bone conductive speaker body (1) is brought into contact with the tragus (31) or a portion in the vicinity thereof. The holding means (2) is of a ring shape having a size accommodated in the concha cavity (30), and both outside face parts thereof come into contact with the inside portion of the tragus (31) and the inside surface of the concha cavity (30) to continuously push them, by which the holding means (2) is locked at that position.

### FIELD OF THE INVENTION

The present invention relates to bone conductive speaker. More particularly, it relates to a speaker for hearing bone conduction sounds by transmitting vibrations based on sound signals to the head bone, and especially a bone conductive speaker capable of being worn at a best suitable position without much effort and without closing the earhole, which is a hearing path for external sounds etc.

### BACKGROUND OF THE INVENTION

As described above, the bone conductive speaker is a speaker for transmitting sounds by vibrating the head bone. When the bone conductive speaker is used, there is a need for bringing the vibration surface thereof into contact with any location on the head and maintaining this state. To meet this need, initially, a method was used in which, like the ordinary headphone, a speaker was pressed against the temple and the mastoid by using a headband. In this method, it was irksome to continuously put the headband on the head, and the wearing state was conspicuous. For this reason, the use of bone conductive speaker was avoided.

A bone conductive speaker of a type such as to be inserted in the earhole like the general earphone has also been used. For the bone conductive speaker of this type, naturally, the earhole is closed, and therefore the hearing of external sounds is inhibited.

In recent years, when a normal hearing person uses a bone conductive speaker, a method has been generally used in which the ordinary sounds are heard through the external auditory canal via the eardrum, and other information is heard via the bone conductive speaker. In this case, the bone conductive speaker is arranged so as not to close the earhole and so as to come into contact with the surroundings of the concha so that the earhole is open.

As the configuration for implementing the above-described method, a behind-the-ear type is generally used. FIG. 7 shows one configuration example of a bone conductive speaker of the behind-the-ear type. In this example, a bone conductive speaker 36 is attached to the tip end of a behind-the-ear member 35 that is put on the auricle from the back. In this case, the bone conductive speaker 36 comes into contact with a portion slightly in front of the tragus.

When a normal hearing person uses the bone conductive speaker of this type, because the user is a normal hearing person, the sounds coming through the external auditory canal tend to be recognized preferentially. As a result, there arises a problem in that the bone conduction sounds are felt to be soft. Needless to say, even the bone conduction sounds of this level can be heard clearly in the case where the external sounds are cut off by putting an earplug.

Accordingly, a test was conducted to confirm a position at which the normal hearing person can use the bone conductive speaker most efficiently without closing the earhole. As the result, it was found that the position determined by the test is the tragus and a position in the vicinity thereof. This is because the tragus portion is vibrated by the vibration of the bone conductive speaker (the tragus acts as the vibration plate of speaker), and the vibrations transmit into the external auditory canal as air conduction sounds, and resultantly, the bone conduction sounds can be heard efficiently.

Such action in the tragus portion also takes place in the case where another auricle portion is vibrated. However, in this case, the whole of the auricle vibrates undesirably, so that there arises a problem in that the sounds leak to the outside. Therefore, in order to reduce the sound leakage to the outside, the auricle portion must be vibrated locally.

Patent document 1: Japanese Patent Laid-Open No. 10-126473
Patent document 2: Japanese Patent Laid-Open No. 11-215581
Patent document 3: Japanese Patent Laid-Open No. 11-331970
Patent document 4: Japanese Patent Laid-Open No. 2002-262381

### SUMMARY OF THE INVENTION

### Problems to be Solved by the Invention

The present invention was made based on the above-described findings. Consequently, it is an object of the present invention to provide a bone conductive speaker in which the hearing of external sounds is not inhibited because the earhole is not closed, the hearing efficiency is high and the sound leakage is small because the tragus portion is vibrated locally, and moreover the configuration is simple and the putting-on and taking-off operations are easy to perform.

### Means for Solving the Problems

To achieve the above object, the bone conductive speaker in accordance with the present invention is characterized in that the bone conductive speaker comprises a bone conductive speaker body and holding means which is attached to the bone conductive speaker body to hold the bone conductive speaker body so that the bone conductive speaker body is brought into contact with the tragus or a portion in the vicinity thereof; and the holding means is of a ring shape having a size accommodated in the concha cavity, and both outside face parts thereof come into contact with the inside portion of the tragus and the inside surface of the concha cavity to continuously push them, by which the holding means is locked at that position.

For example, the holding means is formed into a C shape, and the middle part or one end part thereof is fixed to the bone conductive speaker body. Alternatively, the holding means is formed into a circular shape or an O shape, and an arbitrary part thereof is fixed to the bone conductive speaker body.

In the case where the holding means is formed into a C shape, pads may be provided in both end parts of the holding means to make the contact intimate. Also, in the case where the holding means is formed into a circular shape or an O shape, the thickness thereof may be changed partially so that the holding means is deformed easily.

Preferably, the holding means is made of an elastic material, and also the holding means is coated with a resin or inserted through a resin tube to improve the contact with the skin.

### EFFECT OF THE INVENTION

The bone conductive speaker in accordance with the present invention comprises a bone conductive speaker body and holding means which is attached to the bone conductive speaker body to hold the bone conductive speaker body so that the bone conductive speaker body is brought into contact with the tragus or a portion in the vicinity thereof, and has a simple configuration such that the holding means is of a ring shape having a size accommodated in the concha cavity, and both outside face parts thereof come into contact with the inside portion of the tragus and the inside surface of the concha cavity to continuously push them, by which the holding means is locked at that position. Therefore, the bone conductive speaker has effects that the hearing of external sounds is not inhibited because the earhole is not closed, the hearing efficiency is high and the sound leakage is small because the tragus portion is vibrated locally, and moreover the configuration is simple and the putting-on and taking-off operations are easy to perform.

### BRIEF DESCRIPTION OF THE DRAWINGS

FIG. 1 is a front view and a side view showing a configuration example of a bone conductive speaker in accordance with the present invention.

FIG. 2 is a view showing a method for putting on the bone conductive speaker shown in FIG. 1.

FIG. 3 is a front view and a side view showing another configuration example of a bone conductive speaker in accordance with the present invention.

FIG. 4 is a view showing a method for putting on the bone conductive speaker shown in FIG. 3.

FIG. 5 is a front view and a side view showing still another configuration example of a bone conductive speaker in accordance with the present invention.

FIG. 6 is a view showing a method for putting on the bone conductive speaker shown in FIG. 5.

FIG. 7 is a view showing a method for holding a conventional bone conductive speaker.

### BEST MODE FOR CARRYING OUT THE INVENTION

Preferred embodiments for carrying out the present invention will be described with reference to the accompanying drawings. A bone conductive speaker in accordance with the present invention includes a bone conductive speaker body 1 and holding means that is attached to the bone conductive speaker body 1 to hold the bone conductive speaker body 1 in the vicinity of a tragus 31. The holding means is of a ring shape having a size accommodated in a concha cavity 30, and is characterized in that both outside face parts thereof come into contact with the inside portion of the tragus 31 and the inside surface of the concha cavity 30 with an appropriate pressure to continuously push them, by which the holding means is locked at that position.

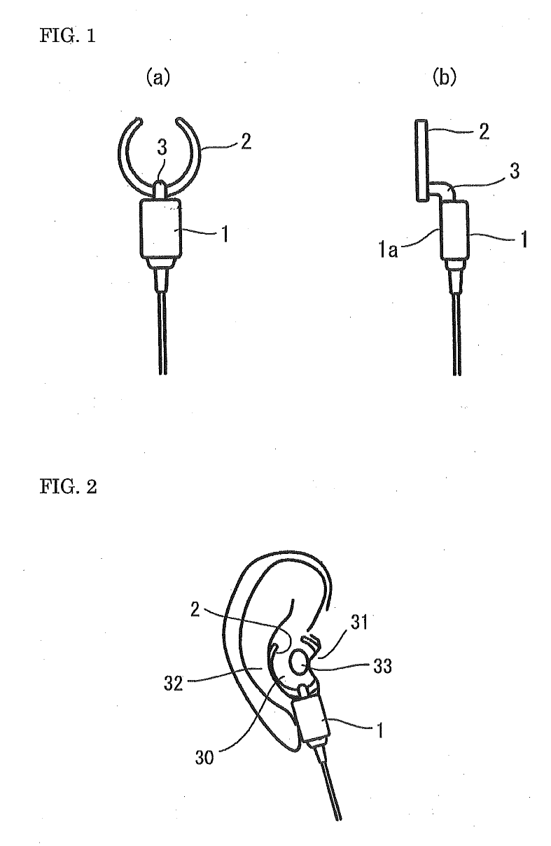

As the configuration of the holding means, various configurations can be thought of. Holding means 2 in a first embodiment shown in FIG. 1 is formed into a C shape by cutting a part of an annular ring, and the middle part thereof is fixed to the tip end of an attaching arm 3 provided on the upper surface of the speaker body 1, by which the holding means 2 is attached to the bone conductive speaker body 1.

The attaching arm 3 has a right-angle shape, so that by fixing the holding means 2 at the tip end of the attaching arm 3, the holding means 2 is shifted from the axis line of the bone conductive speaker body 1 (refer to FIG. 1b). By this shift, a vibration surface 1a of the bone conductive speaker body 1 is brought into contact moderately with the tragus 31 or a portion in the vicinity thereof when the holding means 2 is accommodated in the concha cavity 30.

The holding means 2 shown in the figures is configured so that the right- and left-hand sides thereof are symmetrical. However, the holding means 2 is not necessarily needed to be symmetrical. For example, the lengths or the curvatures of the right and left parts of the holding means 2 may be changed. Especially when a metallic wire rod is used, it is preferable that a resin coating be applied or a resin tube be coveringly put over the total length of the holding means 2 or partially in both side parts that come into contact with the inside portion of the tragus 31 and the inside surface of the concha cavity 30 to improve the contact with the skin (the sense of contact) when the bone conductive speaker is used. The same is true for the holding means of other embodiments described later.

In the case of being made of an elastic material, the holding means 2 can be deformed by pushing. By deforming the holding means 2 by pushing it with a finger, the holding means can be inserted easily into the concha cavity 30. In this case, when the pressing force is released, the holding means 2 tends to return to the original state due to the elastic force thereof. However, since the force acts in the inside portion of the tragus 31 and on the inside surface of the concha cavity 30, with which the holding means 2 is in contact, the holding means 2 is firmly locked thereto, and is held there unless a pull-out force larger than a certain force is applied (refer to FIG. 2).

Even if the holding means 2 is so strong not to be elastically deformed as described above, since the skin with which the holding means 2 comes into contact has elasticity, a state of being firmly locked as described above can be achieved. The holding means 2 in this case is easily put on if it is put on in the state in which the concha cavity 30 is extended by pulling out the concha. The same is true for the holding means of other embodiments described later.

After the bone conductive speaker has been put on as described above, the vibration surface 1a of the bone conductive speaker body 1 is naturally in contact with the tragus 31 or the portion in the vicinity thereof, so that vibrations based on sound signals are transmitted from the contact portion, and therefore sounds can be heard as the bone conduction sounds. At the same time, air conduction sounds are produced by the local vibration of the tragus 31 and/or the portion in the vicinity thereof, and the air conduction sounds enter into the external auditory canal from an earhole 33 and reach the eardrum, by which the air conduction sounds are heard.

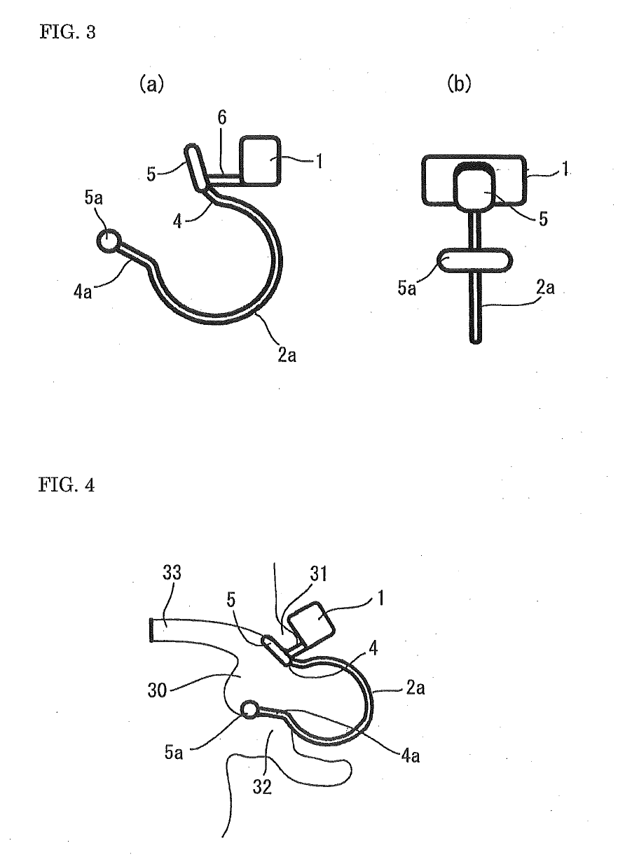

Holding means 2a in a second embodiment shown in FIGS. 3 and 4 is, like the above-described holding means 2, formed into a C shape by using a metal-made or resin-made elastic material or rigid material, and is provided with outward opening parts 4 and 4a so that both end parts of the holding means 2a are open outward. In this case, unlike in the case of the holding means 2, the bone conductive speaker body 1 is attached to one end part of the holding means 2a, in other words, to one outward opening part 4.

Although the holding means 2 in the first embodiment is put on in the vertical state, the holding means 2a in the second embodiment is put on in the horizontal state. Specifically, one outward opening part 4 comes into contact with the inside of the tragus 31, and the other outward opening part 4a comes into contact with the inside surface of the concha cavity 30 (refer to FIG. 4), and the bone conductive speaker body 1 is attached to the outward opening part 4 that comes into contact with the inside of the tragus 31.

The outward opening parts 4 and 4a are provided with pads 5 and 5a projecting slightly in the transverse direction, respectively, to make the contact with the contact portions intimate. The pad 5 of the outward opening part 4 that comes into contact with the inside of the tragus 31 has a flat plate shape. This pad 5 is fixed to an attaching arm 6 extending from the bone conductive speaker body 1, by which the holding means 2a is attached to the bone conductive speaker body 1. The pad 5a of the other outward opening part 4a is formed into, for example, a short round bar shape, and extends in the direction parallel with the surface of the pad 5.

In the case of the second embodiment, when the bone conductive speaker is put on, the holding means 2a is made in the horizontal state, being compressed when it is made of an elastic material, and the outward opening parts 4 and 4a are inserted into the concha cavity 30 in this state. Thereafter, the compressing force is released by removing the finger from the holding means 2a. Then, the holding means 2a opens in the horizontal direction due to the restoring force thereof. The pad 5 comes into contact with the back surface of the tragus 31, and the pad 5a comes into contact with the inside surface of the concha cavity 30, by which the contact portions are pressed by the outward elastic force of the holding means 2a. Thus, the holding means 2a is locked thereto, and is held there unless a pull-out force larger than a certain force is applied.

In the locked state of the holding means 2a, vibrations generated in the bone conductive speaker body 1 is transmitted to the tragus 31 and the surroundings thereof through the pad 5, by which sounds can be heard as bone conduction sounds. Also, as in the case of the first embodiment, air conduction sounds are heard simultaneously with the bone conduction sounds.

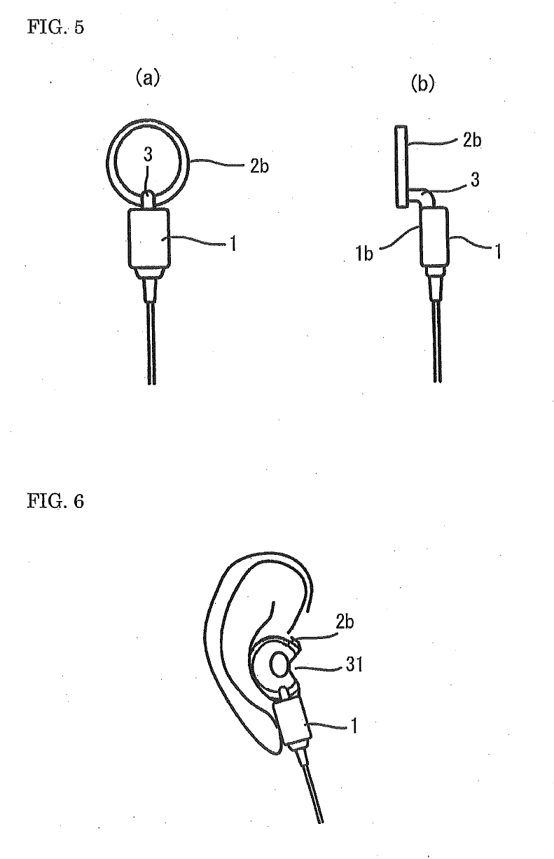

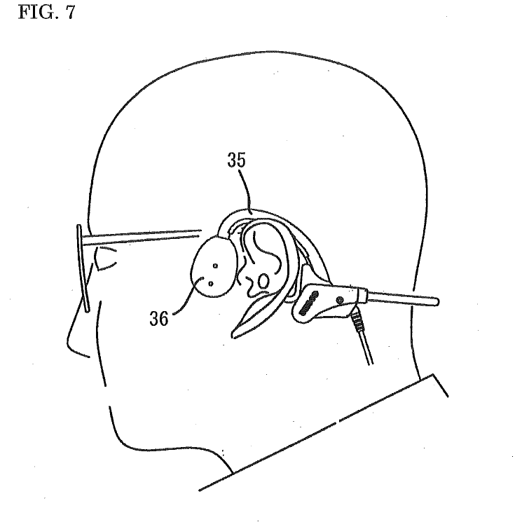

Holding means 2b in a third embodiment shown in FIGS. 5 and 6 is, like the holding means 2 in the first embodiment, formed into a circular shape or an O shape by using a metal-made or resin-made elastic material or rigid material. In this case, to help elastic deformation, the thickness of the holding means 2b is sometimes changed (refer to FIG. 5a).

The holding means 2b differs from the holding means 2 in that it has a circular shape or an O shape. However, the method for attaching the holding means 2b to the bone conductive speaker body 1, the method for putting on the holding means 2b to the ear, and the operation and effects of the holding means 2b are substantially the same as those for the holding means 2, so that the explanation thereof is omitted.

While the present invention has been described in detail to some extent with reference to the preferred embodiments thereof, it will be understood by those skilled in the art that various changes in form and details may be made therein without departing from the spirit and scope of the present invention as defined by the appended claims. In other words, the present invention is not limited in scope by its specified embodiments.

1. A bone conductive speaker characterized in that said bone conductive speaker comprises a bone conductive speaker body and holding means which is attached to said bone conductive speaker body to hold said bone conductive speaker body so that said bone conductive speaker body is brought into contact with a tragus or a portion in the vicinity thereof; and
said holding means is of a ring shape having a size accommodated in a concha cavity, and both outside face parts thereof come into contact with the inside portion of said tragus and the inside surface of said concha cavity to continuously push them, by which said holding means is locked at that position.

2. The bone conductive speaker as set forth in claim 1, wherein said holding means has a C shape, and the middle part thereof is fixed to said bone conductive speaker body.

3. The bone conductive speaker as set forth in claim 1, wherein said holding means has a C shape, and one end part thereof is fixed to said bone conductive speaker body.

4. The bone conductive speaker as set forth in claim 3, wherein said holding means is provided with pads in both end parts thereof.

5. The bone conductive speaker as set forth in claim 1, wherein said holding means has a circular shape or an O shape, and an arbitrary part thereof is fixed to said bone conductive speaker body.

6. The bone conductive speaker as set forth in claim 5, wherein said holding means has a thickness changed partially.

7. The bone conductive speaker as set forth in claim 1 wherein said holding means is made of an elastic material.

8. The bone conductive speaker as set forth in claim 1, wherein said holding means is an elastic wire rod coated with a resin.

9. The bone conductive speaker as set forth in claim 1, wherein said holding means is an elastic wire rod inserted through a resin tube.
